(19) United States
(12) Patent Application Publication
(10) Pub. No.: US 2025/0217821 A1
(43) Pub. Date: Jul. 3, 2025

(54) DEEP LEARNING BASED BRAND RECOGNITION

(71) Applicant: CHECK POINT SOFTWARE TECHNOLOGIES LTD., TEL AVIV (IL)

(72) Inventors: Yair David SPIRA, Tel-Aviv (IL); Vladyslav KOZHUKHOV, Netanya (IL); Dor LIVNE, Sde Moshe (IL)

(73) Assignee: CHECK POINT SOFTWARE TECHNOLOGIES LTD., TEL AVIV (IL)

(21) Appl. No.: 18/399,942

(22) Filed: Dec. 29, 2023

(51) Int. Cl. G06Q 30/0201

(52) U.S. Cl. CPC G06Q 30/0201

(57) ABSTRACT

A computer system and method are provided for generating a brand registry and classifying content as real or fake based on the brand registry. The brand registry is formed by generating a representation of brand content by encoding indicators found in brand content as a vector, identifying clusters in the encoded brand content as separate brands, and determining brand indicators for each brand. Unknown content is classified as real or fake brand content by encoding the unknown content, finding as the most similar brand the brand in the brand registry having a cluster centroid closest to the encoded unknown content, and comparing representative indicators for the unknown content to brand indicators for the most similar brand.

### TECHNICAL FIELD

The present disclosure relates generally to detecting phishing attacks and more particularly to detecting brand spoofing.

### BACKGROUND

Phishing attacks have become an increasingly common security risk. These attacks use deceptive practices to obtain sensitive information from unsuspecting users. Among the various forms of phishing, brand spoofing is a particularly prominent threat.

Brand spoofing involves the creation of counterfeit websites or communications (e.g., emails) that mimic legitimate brands to deceive end users. These counterfeits are designed to appear authentic, often replicating the visual design, tone, and messaging of a genuine brand. The objective of the counterfeit is to trick individuals into believing they are interacting with a legitimate brand's website or representative and to lure unsuspecting users into divulging sensitive information (e.g., login credentials, financial data, personal identification details, etc.).

Traditional security solutions, such as antivirus software and email filters, often fall short in effectively identifying and blocking sophisticated spoofing attempts. Despite ongoing efforts to combat brand spoofing, there is a growing need for advanced solutions that can more effectively detect and prevent brand spoofing.

### SUMMARY

The present disclosure provides a computer system and method for (1) autonomously identifying and categorizing global and local brands and (2) distinguishing between real and spoofed content (e.g., websites, emails, etc.).

While a number of features are described herein with respect to embodiments of the invention; features described with respect to a given embodiment also may be employed in connection with other embodiments. The following description and the annexed drawings set forth certain illustrative embodiments of the invention. These embodiments are indicative, however, of but a few of the various ways in which the principles of the invention may be employed. Other objects, advantages, and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention in which similar reference numerals are used to indicate the same or similar parts in the various views.

FIG. 1 is a block diagram of an exemplary embodiment of a computer system and depicts processing of content.

FIG. 2 is a block diagram of an exemplary embodiment of a representation.

FIG. 3 is a block diagram of an exemplary embodiment of a brand registry.

FIG. 4 is a block diagram of an exemplary embodiment of the computer system of FIG. 1 and depicts processing brand content and unknown content.

FIG. 5 is a flow diagram of an exemplary method for generating a representation of content.

FIG. 6 is a flow diagram of an exemplary method for generating a brand registry and classifying content as real or fake based on the brand registry.

The present invention is described below in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

### DETAILED DESCRIPTION

According to a general embodiment, a computer system and method are provided for generating a brand registry and classifying content as real or fake based on the brand registry. The brand registry is formed by generating a representation of brand content by encoding indicators found in brand content as a vector, identifying clusters in the encoded brand content as separate brands, and determining brand indicators for each brand. Unknown content is classified as real or fake brand content by encoding the unknown content, finding a brand in the brand registry having a cluster centroid closest to the encoded unknown content, and comparing representative indicators for the unknown content to brand indicators for the most similar brand in the brand registry.

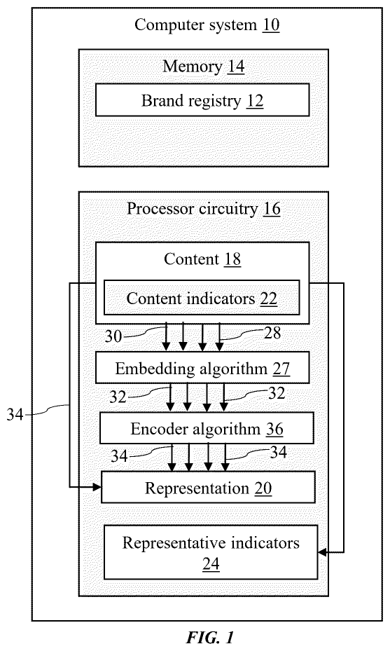

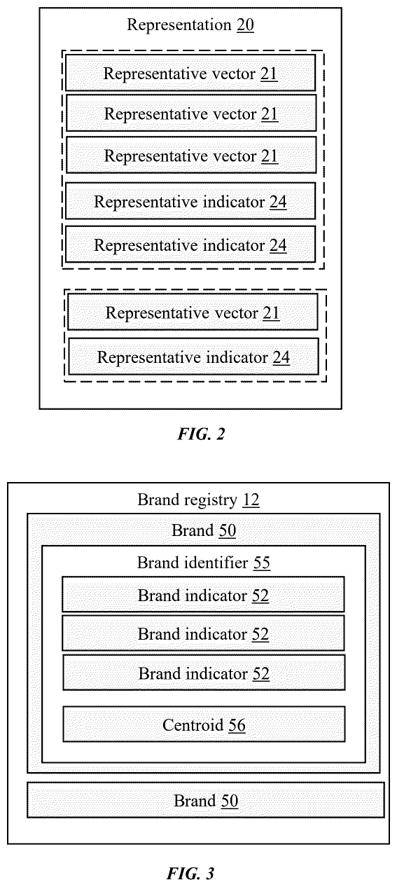

Turning to FIGS. 1 and 2, a computer system 10 is shown for generating a brand registry 12 and classifying content 18 as real or fake based on the brand registry 12. The content 18 may be emails, webpages, or other similar electronic files. The computer system includes a memory 14 and processor circuitry 16. The processor circuitry 16 receives content 18 and generates a representation 20 of the content 18. The representation 20 includes representative vectors 21 and representative indicators 24. The representative vectors 21 may be used to associate content 18 with a brand. The representative indicators 24 may then be used to detect if the content truly belongs to the brand (i.e., whether the content is real or fake).

The processor circuitry 16 generates the representation 20 of the content 18 by extracting content indicators 22 from the received content 18. The processor circuitry 16 then splits the extracted content indicators 22 into visual indicators 28 and textual indicators 30. As an example, the visual indicators 28 may include a rendering of the content (e.g., an entire webpage), one or more images included in the content (e.g., icon(s) in the content), a favicon, etc. For example, only the favicon may be used as a visual indicator 28. The textual indicators may include at least one of domain information for the content, all text from the content, or a copyright notice in the content. For example, the processor circuitry 16 may split the extracted brand indicators into textual indicators using regular expressions (e.g., to identify the copyright notice in a webpage) or using a large language model (LLM).

The content indicators 22 may include both visible content (e.g., text, images, color palette, etc.), non-visible content (e.g., one or more of machine readable information such as CSS code, URL of the page that the resource saved from, URL of the page that the resource come from, URL of the web-page favicon, meta tags of the web-page, inner URLs of the web-page, iframes of the web-page, The <forget/reset password>URL, object with broken links & total links, CSS typography, contents of robots.txt, Alexa rank, etc.), hash (e.g. using MD5, SHA-1, SHA-256 etc.) of the web-page favicon, language of the web-page, favicon base64 encoded, canonical URL, client browser, disabled right click, content source such as local file, does static html contain JavaScript (JS) only, is html smuggling, does HTML body contain JavaScript sending credentials via Ajax, Does HTML body contain JavaScript decoded escaped data, Does HTML body contain JavaScript decoded base64 data, Does HTML body contain a CDATA section, information about external domains references, etc.).

For each of the content indicators 22, the processor circuitry 16 generates a vector 32 as an embedding of the indicator 22 by applying an embedding machine learning algorithm 27 to the content indicator 22. That is, the processor circuitry 16 may embed the content indicators 22 into a form (i.e., a vector) that can be analyzed and grouped to detect brands.

Because the generated vectors 32 may include a large number of dimensions, an encoder machine learning algorithm may be used to reduce the size of the generated vectors 32. That is, for each of the generated vectors 32, the processor circuitry 16 generates as one of the representative vectors 21 a reduced vector 34 by applying an encoder machine learning algorithm 36 to reduce the dimensions of the generated vector 32.

As described above, the processor circuitry 16 also identifies representative indicators 24 from the received content 18. The representative indicators extracted from the received content may include one or more of a security certificate associated with the received content, a domain identifier of the received content, etc. When the representative indicators 24 include the security certificate, this may refer to including information from the security certificate. For example, the common name and organization from the security certificate may be used.

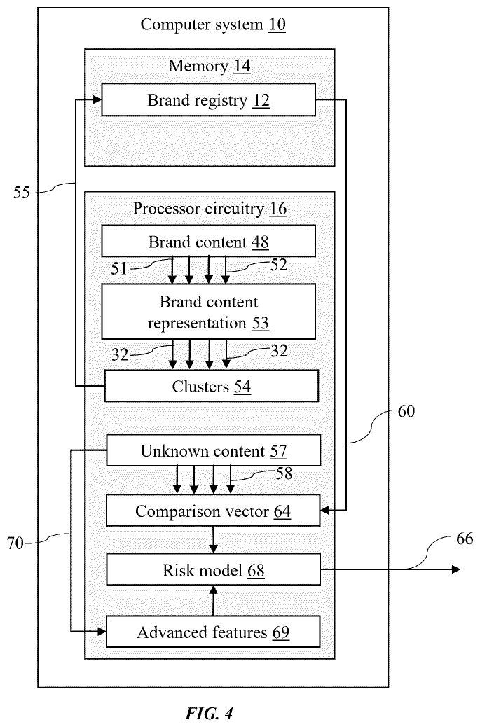

Turning to FIGS. 3 and 4, the processor circuitry 16 generates the brand registry 12 from received brand content 48 for multiple brands 50. The brand content 48 may consist of legitimate brand content (i.e., brand content known to be benign). To do so, the processor circuitry 16 receives brand content 48 for generating the brand registry 12. The brand content 48 may be received from security software, including security software installed on endpoint computers in the form of security agents, plugins and extension such as mail client plugins or browser extensions, network hardware, or any suitable source of online content. The processor circuitry 16 generates a representation for each piece of the received brand content 48 by extracting content indicators as described above. This representation is referred to as a brand content representation 53 (i.e., the representation 20 of the piece of brand content 48) and includes the representative vectors 21 for the brand content 48. The representative vectors 21 for the brand content 48 are referred to as brand content vectors 51.

In general, brands could be global, i.e. recognized or used in disperse geographies, or local, i.e. limited to a small number of countries. It is desirable to be able to recognize a wide set of brands, both global and local. To achieve this goal, brand content 48 could be gathered from multiple sources, preferably on a global scale, and the brands represented in the data could thus be both global as well as local. A brand registry 12 created based on such diverse brand content 48 could then be used to recognize both types of brands.

In general, it is desirable to be able to be automatically create the brand registry 12 without having to manually label the data. It should be noted that the method and system employed to create the brand registry 12 can be employed using unsupervised learning only and do not require any manual labeling of data.

The processor circuitry 16 also determines representative indicators 24 for the brand content 48. These representative indicators are referred to as brand indicators 52 for the processing brand content. The brand indicators 52 are associated with the brand content vectors 51, so that the brand indicators 52 can be used to classify unknown content as real or fake (as is described in further detail below). That is, the representative indicators 24 are stored in the brand registry 12 in association with the representative vectors 21 of the generated brand content representation 53.

After determining the brand content vectors 51, the processor circuitry 16 identifies clusters 54 in the brand content vectors 51. That is, the processor circuitry 16 detects brands by finding clusters in the brand content vectors 51. In this way, the processor circuitry 16 may autonomously identify local and global brands. Each of the identified clusters 54 is associated with the brand content vectors 51 forming the cluster 54. For each of the identified clusters 54, the processor circuitry 16 identifies the cluster 54 as a brand 50 and determines a brand identifier 55 for the brand 50. The brand identifier 55 includes a centroid 56 of the identified cluster 54 and the brand indicators 52 associated with the brand content vectors 51 included in the cluster 54 (i.e., the vectors 51 forming the cluster 54). The centroid 56 may be a vector computed as an average over all the brand content vectors 51 that are part of the cluster. The determined brand identifier 55 is stored in the brand registry 12 and may be used to differentiate between real and fake content as described below.

When generating the brand registry 12, for each of the clusters 54 identified as a brand 50, the processor circuitry 16 may also determine a brand name for the brand identifier 55. The determined brand name may be stored in the brand identifier 55 stored in the brand registry 12 for the brand 50. The brand name may be determined from the brand content 48. For example, the brand name may be determined by analyzing text and/or images in the brand content 48, the domain name of the brand content and/or information extracted from the certificate associated with brand content 48 (such as the X.509 certificate distinguished name, common name, or alternative name).

The processor circuitry 16 uses the brand registry 12 to classify unknown content 57 as real or fake. To do so, the processor circuitry 16 generates a representation 20 of the unknown content as described above. The representation 20 of the unknown content 57 is referred to as an unknown content representation 58 and includes representative vectors 21. The processor circuitry 16 uses this representation 58 to determine the brand from the registry 12 that is the most similar to the unknown content 57 (referred to as a most similar brand 60).

The processor circuitry 16 determines the most similar brand 60 by finding a centroid in the brand registry that is closest to the representative vectors 21 for the unknown content 57. That is, the processor circuitry 16 finds the brand identifier 55 with a centroid 56 that is closest to the representative vectors 21 for the unknown content. For example, the most similar brand 60 may be determined by finding the stored brand representation having the centroid 56 of the cluster 42 with a smallest cosine distance to the representative vectors 21 of the unknown content representation 58.

Once the most similar brand 60 has been found, the processor circuitry 16 compares the unknown content 57 to the most similar brand 60. The more similar the unknown content 57 is to the most similar brand 60, the more likely that the unknown content 57 is real. The comparison between the most similar brand 60 and the unknown content 57 is performed using a comparison vector 64 determined using the representative indicators 24 for the most similar brand 60 (referred to as brand indicators 52) and the representative indicators for the unknown content (referred to as unknown indicators). That is, the processor circuitry 16 compares the brand indicators 52 for the most similar brand 60 and the representative indicators 24 for the unknown content 57 to generate the comparison vector 64.

For example, the comparison vector 64 may be a Boolean vector. Each element of the Boolean vector may indicate whether an indicator of the brand indicators 52 for the most similar brand 60 matches a same indicator of the representative indicators 24 for the unknown content representation 58. For example, each element of the Boolean vector may be mapped to a particular representative indicator. If this particular representative indicator in the most similar brand 60 matches the same particular representative indicator in the unknown content representation 58, then this element may be set equal to true. As an example, if the domain name of the most similar brand 60 matches the domain name of the unknown content 57, then an element in the Boolean vector associated with a comparison of the domain name may be set to true.

The processor circuitry 16 quantifies the information stored in the comparison vector using a risk model 68. In particular, the processor circuitry 16 determines a risk score 66 by applying a risk model 68 (e.g., a machine learning algorithm) to the generated comparison vector 64 and to advanced features 69 determined from the unknown content 57. The processor circuitry 16 determines the advanced features 69 using basic raw data features 70 extracted from the unknown content 57. The basic raw data features 70 may include any features in the unknown content 57 for quantifying the unknown content 57 as real or fake. The processor circuitry 16 then generates advanced features 69 based on the basic raw data features 70. For example, the advanced features 69 may include one or more of a number of images, unique internal reference count, total embedded CSS code, total embedded base64 images, total comments lines in code, total broken pictures, total broken CSS files in the web-page, title of the web-page encoded to base64, texts base64 encoded, hash of the HTML code, or scripts page encoded to base64.

As described above, the comparison vector 64 and the advanced features 69 are used by the risk model 68 to determine a risk score 66 for evaluating a likelihood that the unknown 57 content is real or fake. The risk model 68 may use the comparison vector 64 to determine how many and/or which representative indicators 24 match in the most similar brand 60 and the unknown content 57. The risk model 68 may use the advanced features 69 to detect properties of the unknown content 57 commonly found in fake brand content. The processor circuitry 16 may identify the unknown content as real or fake by outputting a signal indicating that the received unknown content is real or fake.

The computer system 10 may also cause a security result to occur based on a classification of the unknown content 57. For example, when the unknown content 57 is classified as fake, the processor circuitry 16 may block access to the content. Similarly, when the unknown content 57 is classified as real, the processor circuitry 16 may allow access to the content. The processor circuitry 16 may allow access by not blocking access to the content. For example, the computer system 10 may block access by instructing network hardware to prevent network access to a particular URL. Similarly, allowing or blocking access could be performed by security software installed on the endpoint computer trying to access the content. The determination made by the computer system 10 as to whether the content is real or fake could be logged by the security system 10, by the network equipment or by an endpoint security software.

As described above, the content indicators 22 are split into visual indicators 28 and textual indicators 30. The embedding machine learning algorithm 27 may include a vision model for generating the vectors for the visual indicators. Similarly, the embedding machine learning algorithm 27 may include a natural language processing model for generating the vectors for the textual indicators 30.

As an example, the visual indicators 28 may include a rendering of the content (e.g., an entire webpage), one or more images included in the content (e.g., icon(s) in the content), a favicon, etc. In one embodiment, only the favicon for the content may be used as a visual indicator 28. The vision model may be used to generate vectors 32 for the visual indicators 28. That is, the processor circuitry 16 may apply the vision model to each visual indicator 28 to extract visual elements and perform the embedding to generate a vector representing the visual indicator 28. The vision model may be any suitable machine learning algorithm. For example, the vision model applied to the visual indicators may be a hidden layer of a convolutional neural network (CNN), such as a pretrained ResNet-18 model.

The vision model may be trained to learn a hierarchy of features (e.g., from simple to complex) for image classification tasks. That is, when visual content is input into vision model, the visual content may pass through multiple layers of the vision model. Each layer of the vision model may be responsible for learning different features (edges, textures, patterns, etc.). As the visual content passes through the vision model, the early layers of the vision model may capture low-level features, while deeper layers of the vision model may capture high-level features that abstract more complex concepts. Typically, the last hidden layer of a CNN holds the most abstract representations of the input visual content. That is, this last hidden layer may contain a set of neurons that activate in response to various high-level features. The activation values of these neurons can be viewed as a high-dimensional vector (i.e., the generated vector 32) that serves as an embedded representation of the input visual content.

The textual indicators may include at least one of: domain information for the content, all text from the content, or a copyright notice from the content. For example, the processor circuitry 16 may split the extracted brand indicators into textual indicators using regular expressions (e.g., to identify the copyright notice in a webpage). A natural language processing (NLP) model may be used to generate vectors 32 for the textual indicators 28. For example, the NLP model may be based on FastText (a text representation and classification library that uses subword information such as character n-grams). When textual indicators are input into the NLP model, the textual indicators may be broken down into these subwords, and each subword may be associated with a vector in the embedding space. The vectors for each subword in a textual indicator may then be combined (e.g., averaged) to form the generated vector (e.g., single vector) that represents the entire textual indicator. This may result in an embedding vector that encapsulates the semantic and syntactic information of the input text.

As described above, the generated vectors 32 may be reduced to a reduced vector 34 by applying the encoder machine learning algorithm 36. For example, the vectors 32 may have a particular input size (e.g., 712) and the encoder machine learning algorithm 36 may reduce the dimension of the vectors 32 to a reduced vector 34 having a particular output size (e.g., 128). The encoder machine learning algorithm 36 may be used to enhance computational efficiency and remove noise.

The encoder machine learning algorithm 36 may be an encoder neural network derived from a custom autoencoder neural network. The encoder machine learning algorithm 36 may take an input with a given number of dimensions and each layer of the encoder machine learning algorithm 36 may have lower dimensions than a previous layer. The encoder machine learning algorithm 36 may be trained to output a reduced vector 34 that encodes substantially the same information found in the input vector 32. The encoder machine learning algorithm 36 may be trained as a neural network with a first half of the neural network used to reduce a dimensionality of the input vector 32 and a second half of the neural network used to increase the dimensionality of the reduced vector to a same dimensionality of the input vector 32. During training, a difference between the input vector 32 and the output vector may be used as a loss function. Once training is complete, only the first half of the trained neural network may be used. That is, the second half of the trained neural network may be used as the encoder machine learning algorithm 36.

As described above, when generating the brand registry 12, the processor circuitry 16 analyzes the brand content vectors 51 to identify clusters 54 in the brand content vectors 51. The processor circuitry 16 may use any suitable clustering algorithm for identifying the clusters 54, such as DBSCAN (Density-Based Spatial Clustering of Applications with Noise). The risk model may be a gradient boosting algorithm. For example, the risk model may be an XGboost model applied to the comparison vector 64.

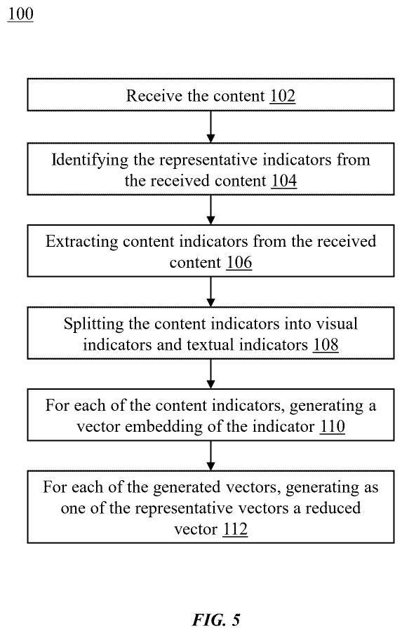

In FIG. 5, an exemplary embodiment of a method 100 is shown for generating a representation of content including representative vectors and representative indicators. In step 102, the content is received with the processor circuitry of the computer system. In step 104, the processor circuitry identifies the representative indicators from the received content. In step 106, the processor circuitry extracts content indicators from the received content. In step 108, the processor circuitry splits the content indicators into visual indicators and textual indicators. In step 110, for each of the content indicators, the processor circuitry generates a vector as an embedding of the indicator by applying an embedding machine learning algorithm to the content indicator. In step 112, for each of the generated vectors, the processor circuitry generates as one of the representative vectors a reduced vector by applying an encoder machine learning algorithm to reduce a dimension of the generated vector.

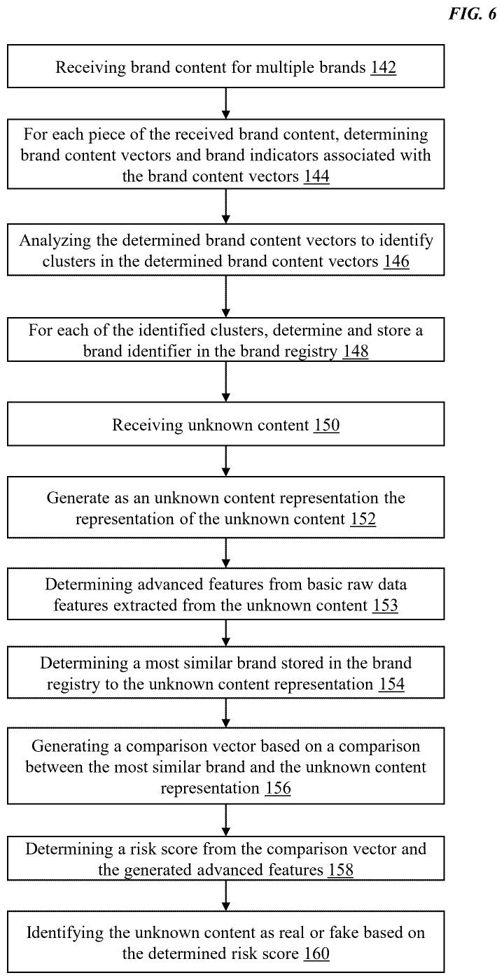

In FIG. 6, a method 140 is shown for generating the brand registry and classifying content as real or fake based on the brand registry. In steps 142-148, the processor circuitry generates the brand registry. In step 142, the processor circuitry receives brand content for multiple brands. In step 144, for each piece of the received brand content, the processor circuitry determines brand content vectors and brand indicators associated with the brand content vectors. In step 146, the processor circuitry analyzes the determined brand content vectors to identify clusters in the determined brand content vectors. In step 148, for each of the identified clusters, the processor circuitry determines a brand identifier for the identified brand including a centroid of the identified cluster and the brand indicators associated with the associated brand content vectors included in the cluster, and stores in the brand registry the determined brand identifier.

In steps 150-160, the processor circuitry classifies unknown content as real or fake. In step 150, the processor circuitry receives the unknown content. In step 152, the processor circuitry generates as an unknown content representation the representation of the unknown content. In step 153, the processor circuitry generates advanced features from basic raw data features extracted from the unknown content. In step 154, the processor circuitry determines as a most similar brand the brand identifier stored in the brand registry having a closest centroid of the cluster to the representative vectors of the unknown content representation. In step 156, the processor circuitry generates a comparison vector based on a comparison between the brand indicators for the most similar brand and the representative indicators for the unknown content representation. In step 158, the processor circuitry determines a risk score by applying as the risk model a machine learning algorithm to the generated comparison vector and the generated advanced features. In step 160, the processor circuitry identifies the unknown content as real or fake based on the determined risk score.

The processor circuitry 16 may have various implementations. For example, the processor circuitry 16 may include any suitable device, such as a processor (e.g., CPU), programmable circuit, integrated circuit, memory and I/O circuits, an application specific integrated circuit, microcontroller, complex programmable logic device, other programmable circuits, or the like. The processor circuitry 16 may also include a non-transitory computer readable medium, such as random-access memory (RAM), a read-only memory (ROM), an erasable programmable read-only memory (EPROM or Flash memory), or any other suitable medium. Instructions for performing the method described below may be stored in the non-transitory computer readable medium and executed by the processor circuitry 16. The processor circuitry 16 may be communicatively coupled to the computer readable medium and network interface through a system bus, mother board, or using any other suitable structure known in the art.

The memory 14 is a non-transitory computer readable medium and may store one or more of the brand registry 12, the embedding machine learning algorithm 27, the encoder machine learning algorithm 36, and the risk model 68.

As will be understood by one of ordinary skill in the art, the computer readable medium (memory) 14 may be, for example, one or more of a buffer, a flash memory, a hard drive, a removable media, a volatile memory, a non-volatile memory, a random-access memory (RAM), or other suitable device. In a typical arrangement, the memory 14 may include a non-volatile memory for long term data storage and a volatile memory that functions as system memory for the processor circuitry 16. The memory 14 may exchange data with the circuitry over a data bus. Accompanying control lines and an address bus between the memory 14 and the circuitry also may be present. The memory 14 is considered a non-transitory computer readable medium.

The computer system 10 may encompass a range of configurations and designs. For example, the computer system 10 may be implemented as a singular computing device, such as a server, desktop computer, laptop, or other standalone units. These individual devices may incorporate essential components like a central processing unit (CPU), memory modules (including random-access memory (RAM) and read-only memory (ROM)), storage devices (like solid-state drives or hard disk drives), and various input/output (I/O) interfaces. Alternatively, the computer system might constitute a network of interconnected computer devices, forming a more complex and integrated system. This could include server clusters, distributed computing environments, or cloud-based infrastructures, where multiple devices are linked via network interfaces to work cohesively, often enhancing processing capabilities, data storage, and redundancy.

All ranges and ratio limits disclosed in the specification and claims may be combined in any manner. Unless specifically stated otherwise, references to “a,” “an,” and/or “the” may include one or more than one, and that reference to an item in the singular may also include the item in the plural.

Although the invention has been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A computer system for generating a brand registry and classifying content as real or fake based on the brand registry, the computer system comprising:
memory comprising a non-transitory computer readable medium and storing the brand registry, an embedding machine learning algorithm, an encoder machine learning algorithm, and a risk model;
processor circuitry configured to:
generate a representation of content including representative vectors and representative indicators comprising:
receiving the content;
identifying the representative indicators from the received content;
extracting content indicators from the received content;
splitting the content indicators into visual indicators and textual indicators;
for each of the content indicators, generating a vector as an embedding of the indicator by applying the embedding machine learning algorithm to the content indicator;
for each of the generated vectors, generating as one of the representative vectors a reduced vector by applying the encoder machine learning algorithm to reduce a dimension of the generated vector;
generate the brand registry comprising:
receiving brand content for multiple brands;
for each piece of the received brand content, determining brand content vectors and brand indicators associated with the brand content vectors by:
generating as a brand content representation the representation of the piece of brand content;
including in the brand content vectors the representative vectors of the generated brand content representation; and
including in the brand indicators the representative indicators of the generated brand content representation in association with the representative vectors of the generated brand content representation; and
analyzing the determined brand content vectors to identify clusters in the determined brand content vectors, wherein each of the identified clusters is associated with the brand content vectors forming the cluster; and
for each of the identified clusters:
identifying the cluster as a brand;
determining a brand identifier for the identified brand including a centroid of the identified cluster and the brand indicators associated with the associated brand content vectors included in the cluster; and
storing in the brand registry the determined brand identifier;
classify unknown content as real or fake comprising:
receiving the unknown content;
generating as an unknown content representation the representation of the unknown content;
generating advanced features based on basic raw data features extracted from the unknown content;
determining as a most similar brand the brand identifier stored in the brand registry having a closest centroid of the cluster to the representative vectors of the unknown content representation;
generating a comparison vector based on a comparison between the brand indicators for the most similar brand and the representative indicators for the unknown content representation;
determining a risk score by applying as the risk model a machine learning algorithm to the generated comparison vector and the generated advanced features; and
identifying the unknown content as real or fake based on the determined risk score.

2. The computer system of claim 1, wherein the generating of the brand registry further comprises, for each of the clusters identified as a brand:
determining a brand name for the brand identifier determined for the identified brand; and
including the determined brand name in the brand identifier stored in the brand registry for the brand.

3. The computer system of claim 1, wherein:
the comparison vector is a Boolean vector; and
each element of the Boolean vector indicates whether an indicator of the brand indicators for the most similar brand matches a same indicator of the representative indicators for the unknown content representation.

4. The computer system of claim 1, wherein the most similar brand is determined by finding the stored brand representation having the centroid of the cluster with a smallest cosine distance to the representative vectors of the unknown content representation.

5. The computer system of claim 1, wherein the content indicators extracted from the received content include at least one of a security certificate associated with the received content or a domain identifier of the received content.

6. The computer system of claim 1, wherein the processor circuitry is further configured to:
when the unknown content is classified as fake, blocking access to the content; and
when the unknown content is classified as real, allowing access to the content.

7. The computer system of claim 1, wherein the embedding machine learning algorithm includes at least one of a vision model or a natural language processing model.

8. The computer system of claim 1, wherein the visual indicators for the received content comprise at least one of a rendering of the content, a favicon of the content, or an image included in the content.

9. The computer system of claim 1, wherein the embedding machine learning algorithm for applied to the visual indicators is a hidden layer of a convolutional neural network (CNN).

10. The computer system of claim 1, wherein the textual indicators for the received content comprise at least one of domain information for the content, all text from the content, or a copyright notice from the content.

11. The computer system of claim 1, wherein the brand content and the unknown content includes at least one of emails or webpages.

12. A method for generating a brand registry and classifying content as real or fake based on the brand registry using a computer system, the method comprising:
generating a representation of content including representative vectors and representative indicators comprising:
receiving the content with processor circuitry of the computer system;
identifying with the processor circuitry the representative indicators from the received content;
extracting content indicators from the received content using the processor circuitry;
splitting the content indicators into visual indicators and textual indicators using the processor circuitry;
for each of the content indicators, using the processor circuitry to generate a vector as an embedding of the indicator by applying an embedding machine learning algorithm to the content indicator; and
for each of the generated vectors, generating as one of the representative vectors a reduced vector by applying with the processor circuitry an encoder machine learning algorithm to reduce a dimension of the generated vector;
generating the brand registry comprising:
receiving brand content for multiple brands with the processor circuitry;
for each piece of the received brand content, determining with the processor circuitry brand content vectors and brand indicators associated with the brand content vectors by:
generating as a brand content representation the representation of the piece of brand content;
including in the brand content vectors the representative vectors of the generated brand content representation; and
including in the brand indicators the representative indicators of the generated brand content representation in association with the representative vectors of the generated brand content representation; and
analyzing the determined brand content vectors with the processor circuitry to identify clusters in the determined brand content vectors, wherein each of the identified clusters is associated with the brand content vectors forming the cluster; and
for each of the identified clusters:
identifying with the processor circuitry the cluster as a brand;
determining with the processor circuitry a brand identifier for the identified brand including a centroid of the identified cluster and the brand indicators associated with the associated brand content vectors included in the cluster; and
storing in the brand registry the determined brand identifier;
classify unknown content as real or fake with the processor circuitry comprising:
receiving the unknown content;
generating as an unknown content representation the representation of the unknown content;
generating advanced features based on basic raw data features extracted from the unknown content;
determining as a most similar brand the brand identifier stored in the brand registry having a closest centroid of the cluster to the representative vectors of the unknown content representation;
generating a comparison vector based on a comparison between the brand indicators for the most similar brand and the representative indicators for the unknown content representation;
determining a risk score by applying as the risk model a machine learning algorithm to the generated comparison vector and the generated advanced features; and
identifying the unknown content as real or fake based on the determined risk score.

13. The method of claim 12, wherein the generating of the brand registry further comprises, for each of the clusters identified as a brand:
determining with the processor circuitry a brand name for the brand identifier determined for the identified brand; and
including the determined brand name in the brand identifier stored in the brand registry for the brand.

14. The method of claim 12- or 13, wherein:
the comparison vector is a Boolean vector; and
each element of the Boolean vector indicates whether an indicator of the brand indicators for the most similar brand matches a same indicator of the representative indicators for the unknown content representation.

15. The method of claim 12, wherein the most similar brand is determined by finding the stored brand representation having the centroid of the cluster with a smallest cosine distance to the representative vectors of the unknown content representation.

16. The method of claim 12, wherein the content indicators extracted from the received content include at least one of a security certificate associated with the received content or a domain identifier of the received content.

17. The method of claim 12, further comprising:
when the unknown content is classified as fake, blocking access to the content with the processor circuitry; and
when the unknown content is classified as real, allowing access to the content with the processor circuitry.

18. The method of claim 12, wherein the embedding machine learning algorithm includes at least one of a vision model or a natural language processing model.

19. The method of claim 12, wherein the visual indicators for the received content comprise at least one of a rendering of the content, a favicon of the content, or an image included in the content.

20. The method of claim 12, wherein the textual indicators for the received content comprise at least one of domain information for the content, all text from the content, or a copyright notice from the content.
